(19) United States
(12) Patent Application Publication
(10) Pub. No.: US 2026/0079035 A1
(43) Pub. Date: Mar. 19, 2026

(54) PISTON FOR DOSING PUMP

(71) Applicant: Thomas STEGMAIER, Aichwald (DE)

(72) Inventor: Thomas STEGMAIER, Aichwald (DE)

(21) Appl. No.: 19/326,048

(22) Filed: Sep. 11, 2025

(30) Foreign Application Priority Data
Sep. 13, 2024 (DE) 102024126433.0

(51) Int. Cl. G01F 11/02

(52) U.S. Cl. CPC G01F 11/021

(57) ABSTRACT

A dosing piston for a dosing pump has a generally cylindrical piston body extending along an axis. A flexible seal body is fitted to but separate from the piston body, forms part of an outer surface of the piston body, and forms with the piston body an annular compartment. A seal ring is formed on and projects radially outward from the seal body, and an elastic biasing element in the annular compartment bears radially inward on the piston body and radially outward on the seal body at the seal ring.

### FIELD OF THE INVENTION

The present invention relates to a dosing pump. More particularly this invention concerns a piston for a dosing pump.

### BACKGROUND OF THE INVENTION

A dosing piston is generally known from the prior art and forms the core component of a dosing pump usually used to pump a predefined quantity of liquid or pasty products into a container. In particular, these products are foodstuffs such as dairy products, fruit jellies or the like.

The dosing piston is centered on an axis and axially reciprocal in a dosing cylinder by a drive or actuator. The diameter of the dosing cylinder and the stroke of the dosing piston determine the quantity that can be filled per cycle within a container.

The typical dosing-pump piston has a flexible seal assembly forming part of the outer surface of the piston, and an elastic biasing element is braced radially between the piston body and the seal assembly to bias a seal body of the piston radially outward.

It is crucial here that the dosing piston is guided along the inner walls of the dosing cylinder in a sealed manner so that no filling material can enter the area behind the dosing piston or even into the dosing piston. On the one hand, this is crucial for ensuring a constant dosing quantity during operation. On the other hand, it also prevents perishable products from entering areas of the dosing pump that are difficult or impossible to clean. Accordingly, a seal is used to ensure that the filling goods are not contaminated by germs or bacteria during operation.

At the same time, however, it is important that the dosing piston continues to slide along the inner wall of the dosing cylinder with as little friction as possible despite adequate sealing. This is usually achieved by the dosing piston only making sealing contact with the inner wall of the dosing cylinder in a comparatively narrow area in relation to the axial length of the dosing piston. Accordingly, there is only a narrow contact surface between the dosing piston and the dosing cylinder that keeps friction between these two components low.

In practice, it is known to provide one or more spaced-apart seal rings on the piston body, each of which forms an annular sealing surface via which a seal is created on the inner wall surfaces of the dosing cylinder in which the piston moves. However, it is problematic here that the seal rings used for this purpose are usually made of an elastomeric material that wears out within a short time as a result of the contact pressure on the inner wall for material-related reasons and, as a result, no sufficient contact pressure can be guaranteed on the inner wall for reasons of wear. As a result, it is necessary to replace the seal rings in comparatively short intervals. This disrupts the process and thus also the operation and production must be stopped.

In contrast, DE 198 59 753 therefore teaches an embodiment in which the piston body is formed essentially from a solid material with an annular compartment, and the piston body has a comparatively thin integral wall radially outwardly closing the annular compartment and serving as the seal ring. With a suitable choice of material, the piston body thus has an outer surface that is flexible in the area of the annular compartment and therefore fundamentally suitable for creating a seal. In order to achieve sufficient pretension between the seal assembly and the dosing cylinder, the biasing element is inside the annular compartment and presses the thin wall surface against the inner wall surface of the dosing cylinder. This biasing element can be an elastomeric ring. Alternatively, it is also possible to provide a metallic spring element that generates the corresponding contact pressure.

Such a design has the advantage that sufficient contact pressure can be generated over a long period of time due to the suitable design of the biasing element. At the same time, such a design has the advantage that, due to the essentially one-piece design of the outer surface, there is no gap within the dosing piston through which filling material can penetrate into areas of the dosing piston, which reduces the risk of germ contamination.

Although such a design has proven itself so far, it has also been shown that replacing the elastomeric biasing element is essentially only possible by replacing the entire dosing piston. At the same time, depending on the type of production or the product to be filled, it is sometimes necessary to adapt the sealing geometry. Depending on the product to be filled, different materials must also be provided for the piston, at least in the area of the seal assembly. Accordingly, the solutions known from the prior art lack sufficient flexibility, since the entire dosing piston usually has to be replaced.

### OBJECTS OF THE INVENTION

It is therefore an object of the present invention to provide an improved piston for a dosing pump.

Another object is the provision of such an improved piston for a dosing pump that overcomes the above-given disadvantages, in particular that can easily be repaired or partially replaced and that also in inexpensive to manufacture.

### SUMMARY OF THE INVENTION

A dosing piston for a dosing pump has according to the invention a generally cylindrical piston body extending along an axis. A flexible seal body is fitted to but separate from the piston body, forms part of an outer surface of the piston body, and forms with the piston body an annular compartment. A seal ring is formed on and projects radially outward from the seal body, and an elastic biasing element in the annular compartment bears radially inward on the piston body and radially outward on the seal body at the seal ring.

Thus, the seal ring is provided a separate seal body carried on the piston body and the biasing element is in an annular compartment formed between the seal body and the piston body.

According to the invention, the seal ring is on a separately formed seal body that is thus not integral with the piston body but is a separate part formed of a separate, more flexible material. In this case, the seal body only forms a portion of the cylindrical outer surface of the dosing piston. The portion can be between 30% and 90% of the total outer surface area of the normally generally cylindrical piston.

The advantage of such a design is that, on the one hand, the properties of the seal assembly can be selected independently of the material of the piston body. On the other hand, the separate design also makes it possible to detachably install the seal body on the piston body so that the seal body and/or the biasing element can be replaced depending on the application or the state of wear.

By selecting a suitable material for the seal body and ring, which are normally of one-piece construction, it is possible to deal with different types of filling goods so that, for example, particularly chemically stable materials can be used if this is required for certain filling goods. The contact pressure between the seal assembly and the dosing cylinder can also be specifically adjusted by selecting a biasing element of appropriate size and stiffness. This results in a modular design of the dosing piston that can always be adapted and maintained depending on the requirements placed on the dosing piston. In contrast to the solutions known to date from the state of the art, it is therefore not necessary to replace the entire dosing piston. At the same time, however, the advantage of incorporating a biasing element can also be utilized, via which the contact pressure is precisely determined.

According to a further development of the invention, the seal body has the outwardly projecting seal ring. Accordingly, the seal ring and seal body essentially form the seal assembly that slides along the inner wall of a dosing cylinder. The design of this seal ring is therefore decisive for the sealing effect and the sliding properties. In this context, a design in which the seal ring is of U-shaped cross-section is particularly preferred. The seal ring also preferably is annular. This U-section essentially forms two projections that are offset parallel to each other in the axial direction, which are pressed together in the radial direction depending on the contact pressure and essentially form linear sealing surfaces. However, it is of course also conceivable that the seal ring has other cross-sections. For example, the dosing lip can have not just two but three, four or more linear projections or ridges that are then deformed when used inside a dosing cylinder.

According to a further development of the invention, the seal body is inserted with an undercut in a circumferential groove of the piston body. The introduction of a circumferential groove has the advantage that the seal body can be flush with the surface, at least in relation to the adjacent sections of the piston body, so that no step is provided between the seal body and the piston body. The undercut then ensures that the seal body is held within the circumferential groove. In addition, the undercut can also be used to ensure a sufficient sealing effect between the seal body and the piston body by an essentially form-fit design with the circumferential groove that prevents the ingress of filling material into the dosing piston. Accordingly, the undercut serves not only to secure the seal body within the circumferential groove but also to seal it against the ingress of filling material. This is particularly useful when dealing with foodstuffs in order to prevent the growth of germs or bacteria over a longer period of operation.

Although the provision of a corresponding undercut alone provides a certain sealing function, the design of this undercut contributes significantly to the sealing effect. A design in which the circumferential groove has a width that tapers outwards toward the outer piston-body surface is particularly preferred. In this case, the width of the circumferential groove refers to the circumferential edges that are spaced axially apart. Starting from an essentially rotationally symmetrical design of the dosing piston, the width of the circumferential groove thus decreases radially outwards starting from a groove floor. In the case of an essentially form-fit design of the seal body, the tapered shape of the circumferential groove thus secures the seal body within the circumferential groove.

In principle, such a taper can be achieved by introducing a stepped shape. However, a design in which the width tapers continuously toward the outside, at least in sections, is particularly preferred. According to such a design, the circumferential groove forms a frustoconical end face extending at a taper angle and projecting in the axial direction at least at one groove edge, but preferably at both groove edges. The taper angle is advantageously between 18 [symbol] and 35°, particularly preferably between 20 [symbol] and 30°. For example, the taper angle can be 25°.

A preferred further development provides that the seal body has a frustoconical contact face confronting to the frustoconical end face of the piston body, and the end faces form a gap angle of at least 5°. Preferably, the angle is between 5° and 15°, in particular between 5° and 10°. Accordingly, according to such an embodiment, both the seal body and the circumferential groove have a width that tapers continuously toward the outside, although the degree of tapering differs from one another. Due to the tapered design of the collar section, the piston body presses linearly into the seal body via the collar section, resulting in an essentially gap-free design.

A preferred embodiment of the invention further provides that the seal body is axially between a main part and a separate retainer of the piston body. Accordingly, the piston body is formed from at least two separate parts that abut one another in the axial direction. An arrangement of the seal body between the main part and the retainer has the advantage that it can be not only positively but also at least partially clamped between the two components, whereby on the one hand a securing effect and on the other hand a sufficient sealing effect is achieved between the seal body and the piston body. According to such an embodiment, the main part and the retainer preferably connect directly to the seal body, so that the projecting collar sections are then also on the main part and/or the retainer.

Furthermore, the main part and the retainer are preferably detachably connected to each other. Accordingly, the main part can be detached from the retainer and axially separated from the latter. In this case, the seal body and the biasing element are then exposed and can also be detached from the piston body by axially pulling them off. A new seal body and/or a new biasing element can then be inserted in reverse order and fixed in place by fastening the main part to the retainer.

The biasing element itself preferably is held in a groove of the seal body. This groove is on a side of the seal body opposite the outer surface and preferably extends circumferentially. Furthermore, the groove is preferably opposite the seal ring that ensures that the biasing element is always at the level of the seal ring, whereby the groove ensures that displacement in the axial direction is prevented. Accordingly, the biasing element can always act directly on the seal ring.

The biasing element is also preferably an elastomeric ring. This ring-shaped elastomer body can then engage along the entire circumference in the ring-shaped groove of the piston body, so that a uniform contact pressure and therefore a uniform sealing effect is achieved along the entire circumference. The elastomer body is preferably made of a material that provides sufficient elasticity on the one hand and sufficient contact pressure on the other. Preferably, the elastomer body can be formed at least partially, in particular completely, from a silicone rubber (VMQ). However, it is of course also possible to form the elastomer body from other materials or from a mixture of several materials. The elastomer biasing element also preferably has an essentially rectangular cross-section.

The seal ring itself is preferably made of a thermoplastic material. Polytetrafluoroethylene (PTFE) has proven to be particularly suitable here, as it is highly resistant to foodstuffs. However, it is also possible to use other thermoplastic materials such as polyoxymethylene (POM) or polyethylene (PE), in particular ultra-high molecular weight polyethylene (UHMWPE).

The piston body or its main part and/or the retainer can be made of steel, in particular stainless steel, or aluminum. Since the piston body itself is not responsible for the sealing effect, the material in the area of the outer surface should not be selected on the basis of its flexible properties. Stainless steel is particularly suitable for use with food, as it is highly resistant to food and can be cleaned or sterilized easily and effectively.

A further development of the dosing piston also provides for a piston rod to be detachably attached to the piston body. This piston rod then establishes an operative connection with an actuator so that a reciprocating movement can be transmitted to the piston body. A particularly preferred embodiment in this context is one in which the piston rod is attached to the piston body via a bayonet coupling. A bayonet coupling of this type enables fastening in a simple manner, whereby after inserting the piston rod into the piston body, a simple rotation locks them together. This type of fastening is therefore much simpler than with a screwthread, as the piston body only needs to be rotated by a certain angle. According to one such embodiment, the piston rod has a coupling stem, and at least two radially outwardly projecting fastening bolts are on the coupling stem. These fastening bolts are retained inside the piston body via corresponding grooves and then create a positive fit with the piston body by twisting. Usually, the fastening bolts are inside the mounting part in the fastened state, so that the retainer only needs to have a suitable hole.

The coupling stem preferably connects to a front end of the piston and a sealing washer is between the piston body and the front end. The coupling stem preferably has a smaller diameter than the front end, so that an axial contact surface is formed between the piston body and the front end. By providing a sealing washer, a seal can be created between the piston body and the piston rod. In addition or alternatively, this sealing washer can also act as an antirotation device or lock washer.

A further development of the invention also provides for the seal body to be held clamped between the main part and the retainer via the bayonet coupling. Accordingly, the bayonet coupling is responsible for ensuring that not only the piston rod is attached to the piston body. In fact, the bayonet coupling holds the seal body within the piston body and can also be responsible for ensuring that all the parts of the dosing piston are fixed together. In this case, the piston rod holds the main part by means of the bayonet coupling on the one hand and also has a contact surface by providing a tapered coupling stem, so that all components are then clamped against each other between the main part and the contact surface.

A further object of the invention is a dosing pump with a dosing cylinder and a dosing piston according to the invention which slides in the dosing cylinder. The dosing piston can then be connected to a drive via a piston rod attached thereto. This drive is set up to reciprocate the dosing piston. The dosing piston is designed according to the previous descriptions in accordance with the invention.

### BRIEF DESCRIPTION OF THE DRAWING

The above and other objects, features, and advantages will become more readily apparent from the following description, reference being made to the accompanying drawing in which:

FIG. 1 is a side view of part of a dosing pump with a dosing piston according to the invention;

FIG. 2 is an isometric partly sectional view of the dosing piston according to the invention;

FIG. 3 is an exploded side view of the dosing piston according to the invention; and

FIG. 4 is a view of a detail of FIG. 3 in the area of the transition between the piston body and the seal body.

### SPECIFIC DESCRIPTION OF THE INVENTION

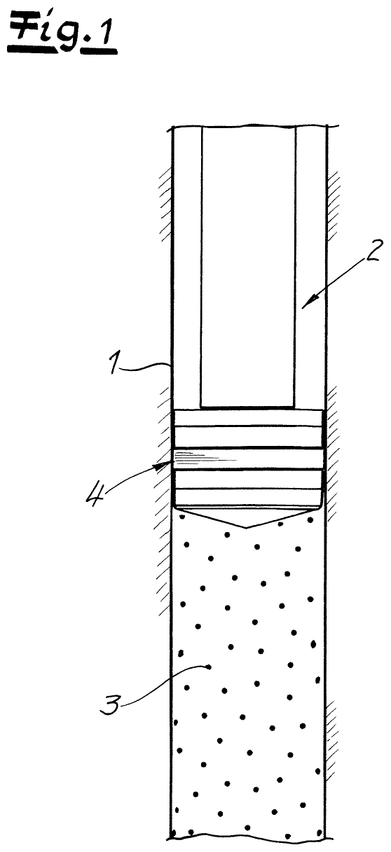

FIG. 1 shows a dosing pump with a dosing cylinder 1 and a dosing piston 2 that slide in the dosing cylinder 1 and are centered on an axis A. The dosing piston 2 is sealed against the walls of the dosing cylinder 1 so that a filling material 3 enters the dosing cylinder 1 during a rearward (here upward) movement, and is discharged during an opposite forward (here downward) movement of the dosing piston 2 and filled into an unillustrated container. The diameter of the dosing cylinder 1 and the stroke length of the dosing piston 2 determine the quantity that can be filled into the container per stroke. This makes it possible to precisely dose the filled quantity.

It is particularly important that the dosing piston 2 be sealed against the inner wall surface of the dosing cylinder 1 so that no filling material 3 can get behind the dosing cylinder 1. This is particularly important if the product 3 is a foodstuff because a suitable seal ensures that no germs or bacteria can form in the rear area of the dosing cylinder 1. Furthermore, cleaning is also significantly easier.

In view of this, it is known that typical dosing pistons 2 have a seal assembly 4 via which the dosing piston 2 rests against the inner walls of the dosing cylinder. This seal assembly 4 is designed in such a way that, on the one hand, sufficient sealing is ensured while, on the other hand, friction is reduced to a level that allows the dosing piston 2 to slide smoothly along the inner walls of the dosing cylinder 1. This sealing must be ensured over as long a service life as possible. At the same time, however, it is also necessary that the components of the dosing piston 2 forming the seal assembly 4 can be replaced at suitable intervals. Such replacement may also be necessary if certain types of products 3 are to be dispensed.

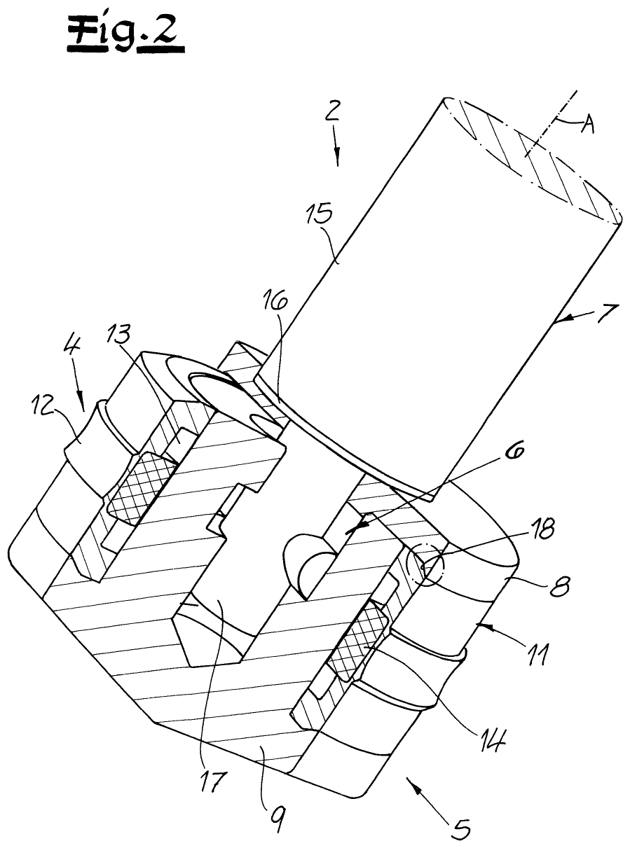

FIG. 2 shows a detailed embodiment of the dosing piston 2. The dosing piston 2 has a body 5 that is attached to a piston rod 7 via a bayonet coupling 6. The piston body 6 consists of a main part 9 and a retainer 8 on it. All parts of the piston 2 except the bayonet coupling are rotation symmetrical about the axis A.

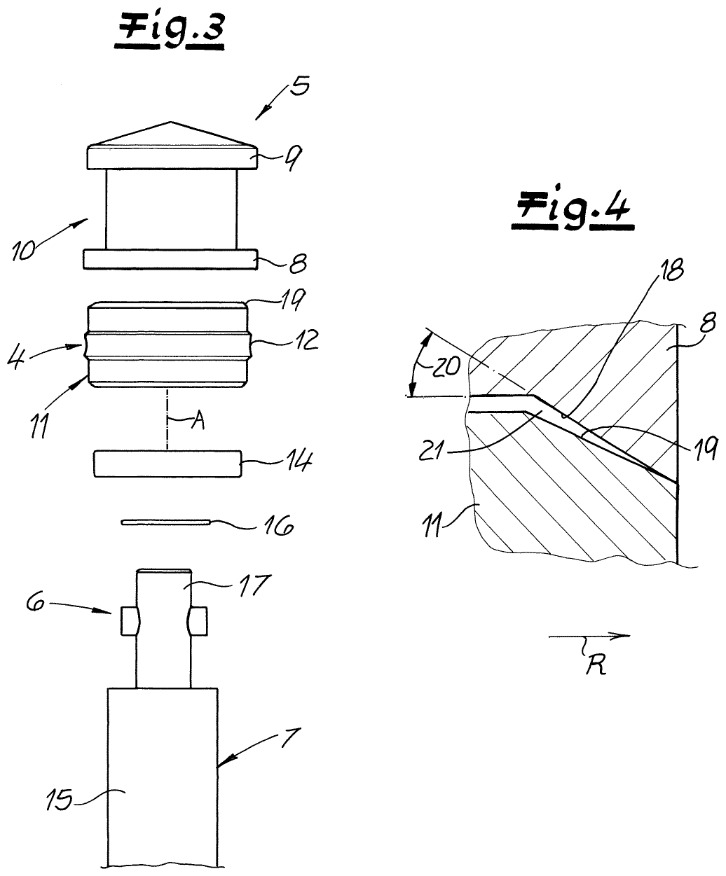

The exact design and arrangement of the individual components of the dosing piston 2 can also be seen in the exploded view in FIG. 3.

The retainer 8 and the main part 9 form a circumferential radially outwardly open groove 10 holding a seal body 11 that is separate from the piston body 5 and on which the flexible seal assembly 4 is carried. Here, the piston body 5 can be made of stainless steel, for example, while the material for the seal body 11 is preferably of a thermoplastic elastomer such as PTFE. A U-section seal ring 12 is provided that extends annularly around the piston body 5 and forms part of the seal assembly 4.

In order to achieve sufficient contact pressure of the seal assembly 4 on the inner walls of the dosing cylinder 1, a biasing element 14 in the form of an elastomeric ring is also provided in an annular compartment 13 radially between the seal body 11 and the main part 9 of the piston body 2. This biasing element 14 is made of an elastic material, preferably silicone rubber, and is directly radially inward of the seal assembly 4 or the seal ring 12. Accordingly, the piston body 2, the seal body 11 and the biasing element 14 are components formed separately from one another.

Furthermore, all components of the dosing piston 2 are clamped to the piston rod 7 solely by the bayonet coupling 6. To this end, the bayonet coupling 6 is anchored in the main part 9, while an axially front end 15 of the piston rod 7 acts on the retainer 8 and the seal body 11 is held clamped between the retainer 8 and the main part 9. In addition, a sealing washer 16 is provided between the piston end 15 and the retainer 8 that provides a seal on the one hand and prevents relative rotation on the other. The piston rod 7 then engages via a coaxial, concentric, and smaller-diameter stem 17 through the retainer 8 into the main part 9 and is then fastened via the bayonet coupling 6 mentioned above.

FIG. 4 is a detailed view of the structure in the dot-dash circle of FIG. 2. Here it is clear that both the steel retainer 8 and the plastic seal body 11 have axially confronting frustoconical end faces 18 and 19 tapering axially rearwardly and extending in a radial outward direction R to the outer surface of the piston body 5. This leads to the formation of an annular gap 21 between the faces 18 and 19 that is of radially inwardly increasing axial width. The face 18 extends at an angle 20 to a plane perpendicular to the axis A. The retainer presses forward on the element 11 with an axial force concentrated at the radial outer edges of the faces 18 and 19 for excellent sealing. When tightened axially, the two faces 18 and 19 form a smaller angle relative to each other and can, when fully tightened, be virtually parallel and in surface contact with each other due to the deformability of the element 11.

1. A dosing piston for a dosing pump, the piston comprising:
a generally cylindrical piston body extending along an axis;
a flexible seal body fitted to but separate from the piston body, forming part of an outer surface of the piston body, and forming with the piston body an annular compartment;
a seal ring formed on and projecting radially outward from the seal body level with the compartment; and
an elastic biasing element in the annular compartment bearing radially inward on the piston body and radially outward on the seal body at the seal ring.

2. The dosing piston according to claim 1, wherein the seal ring projects radially outward past an outer wall surface of the piston body and of the seal body.

3. The dosing piston according to claim 1, wherein the piston body is formed with a circumferential radially outward groove receiving the seal ring and forming therewith the annular compartment holding the biasing element.

4. The dosing piston according to claim 3, wherein the groove is of an axial width that tapers radially outward.

5. The dosing piston according to claim 3, wherein the groove has a pair of axially spaced edges at least one which is an outer edge of an annular frustoconical wall face of the groove and overhangs the groove and the seal ring.

6. The dosing piston according to claim 3, wherein the groove has two outer edges at an outer surface of the and each formed by an outer edge of a respective annular frustoconical wall face of the groove and overhangs the groove and the seal ring.

7. The dosing piston according to claim 6, wherein the seal ring has frustoconical outer faces confronting and facing the respective frustoconical wall faces of the groove.

8. The dosing piston according to claim 6, wherein each frustoconical outer face of the seal ring contacts and forms with the respective frustoconical wall face of the groove a radially inwardly open angle between 5° and 10°.

9. The dosing piston according to claim 3, wherein the piston body is formed by a main part and a separate retainer together forming the groove holding the seal ring, the retainer being axially joined to and removable from the main part.

10. The dosing piston according to claim 1 wherein the biasing element is an elastomeric ring.

11. The dosing piston according to claim 1, wherein the seal element is integrally formed with the seal ring of a thermoplastic.

12. The dosing piston according to claim 11, wherein the piston body is formed of metal.

13. The dosing piston according to claim 12, further comprising:
a piston rod detachably connected to the piston body.

14. The dosing piston according to claim 13, further comprising:
a bayonet coupling releasable securing the piston rod to the piston body.

15. The dosing piston according to claim 14, wherein the piston rod comprises a smaller-diameter end stem projecting into the piston body and forming part of the bayonet coupling.

16. The dosing piston according to claim 15, further comprising:
a compressible washer between the piston rod and the piston rod and surrounding the stem and clamped between the piston rod and the piston body in a locked condition of the bayonet coupling.

17. The dosing piston according to claim 1, wherein the seal body is a substantially cylindrical sleeve.

18. The dosing piston according to claim 1, wherein the seal body set in the piston body and has an outer diameter corresponding substantially to an outer diameter of the piston body to each axial side of the seal body.

19. A dosing pump having a cylinder holding the dosing piston of claim 1.
